(19) United States
(12) Patent Application Publication
(10) Pub. No.: US 2019/0150462 A1
(43) Pub. Date: May 23, 2019

(54) PROCESS FOR REDUCING THE AMOUNT OF MIXED PHASES DURING CONCENTRATION OF MILK STREAMS

(71) Applicant: DMK Deutsches Milchkontor GmbH, Zeven (DE)

(72) Inventor: Christian STADLER, Zeven (DE)

(21) Appl. No.: 16/192,951

(22) Filed: Nov. 16, 2018

(30) Foreign Application Priority Data
Nov. 23, 2017 (EP) 17203252.6

(51) Int. Cl. A23C 1/12; A23C 1/14; A23C 7/02

(52) U.S. Cl. CPC A23C 1/12; A23C 7/02; A23C 1/14

(57) ABSTRACT

A process for reducing the occurrence of mixed phases when concentrating dairy streams is suggested, comprising the following steps
(i) providing at least one evaporation reactor;
(ii) providing at least two stacked containers, which can be individually controlled by an evaporation reactor, or by the evaporation reactors;
   by proceeding as follows:
(a) continuously concentrating a dairy stream in an evaporation reactor R1 and feeding the concentrate such obtained into the first stacked container V1, draining the container discontinuously and processing the concentrate contained therein;
(b) increasing the performance of the evaporation reactor R1 such that the concentrate obtained has a higher dry matter content;
(c) shutting down, rinsing, and removing of product from the evaporation reactor R1 using water, and, subsequently,
(d) feeding the concentrate, which had been diluted with the rinsing water, into another stacked container V3, where the mixed phase MP2 such obtained is gathered, and is then further processed or discharged.

### CROSS REFERENCE TO RELATED APPLICATION

This application claims the benefit of European Patent Application No. EP 17203252.6, titled Process for Reducing the Amount of Mixed Phases During Concentration of Milk Streams, filed on Nov. 23, 2017, which is incorporated by reference herein in its entirety.

### FIELD OF THE INVENTION

The invention is in the field of the dairy industry and relates to a process for reducing the quantities of waste when concentrating dairy streams, particularly of skimmed milk.

### BACKGROUND

One of the most important process steps in the dairy industry is the concentration of dairy streams, i.e., the separation of water. The aim is to produce concentrates having a dry matter content of about 50% by weight, which can be stored and transported at reduced effort. The concentration process is performed within the range of about 100° C.; however, as the production of tower powders requires significantly higher temperatures, such concentrates may be dried with a noticeably lower total energy input.

A typical example illustrating the problem that is the subject matter of the present invention is the production of skimmed milk concentrates. In a first step, solids are removed from the raw milk, which is then skimmed, before the skimmed milk having a dry matter content of about 10% by weight such obtained is pre-concentrated to about 30 to 40% by weight, is stacked, and is subsequently concentrated to about 50% by weight.

The concentrates may then be processed to obtain, for example, corresponding tower powders. The concentration step is usually carried out in evaporation reactors (“evaporators”), in which the vapours are typically mechanically compressed and then condensed into the corresponding stacked containers, which can hold a few thousand litres of product. The collecting containers usually serve to feed the drying towers.

However, the reactors are susceptible to bacterial contamination, as they operate at temperatures at which particularly thermophilic germs exhibit a strong growth. Therefore, after relatively short running periods of 6 to 12 hours, the reactors must be shut down and extensively cleaned. In this process, the amount of concentrate still within the reactor is pushed out using hot water, which leads to the formation of a so-called mixed phase, which only has a dry matter content of 35 to 40% by weight at the end. Assuming a throughput of typically 15,000 litres/day and two or three standstills for cleaning, each plant produces 2,000 to 3,000 kg mixed phase on a daily basis. Usually, pairs of evaporation reactors are employed, i.e., whenever one of them is shut down, the dairy stream is redirected, and the second reactor is started up, as a result of which they are always operating with an offset, allowing a continuous production.

The mixed phases are collected; their utilisation, however, is problematic due to longer-term storage (“stacking”) and frequently occurring physical and bacteriological changes during storage. Typically, the mixed phases are suitable for the production of low-price products for animal nutrition, if at all; often, however, they must be discharged.

It is obvious that it is desirable to reduce the amount of mixed phases, which are difficult to utilise, and already a small optimisation may immediately entail a significant saving due to the large amounts produced, i.e., this may considerably improve the economics of this process.

The object of the present invention was to remedy the disadvantages of the state of the art described above and to provide a correspondingly enhanced process.

### SUMMARY

The present invention relates to a process for reducing the occurrence of mixed phases while concentrating dairy streams, comprising the steps of
(i) providing at least one evaporation reactor;
(ii) providing at least two stacked containers, which can be controlled individually by one or both evaporation reactors;
by proceeding as follows:
(a) continuously concentrating a dairy stream having a dry matter content of about 30 to about 40% by weight in an evaporation reactor R1 until obtaining a dry matter content of about 50% by weight, and feeding the concentrate such obtained into the first stacked container V1 for a running period of about 5 to about 15 hours, draining the container discontinuously and processing the concentrate contained therein;
(b) increasing the performance of the evaporation reactor R1 for a maximum of 2 hours before the scheduled end of each respective running period such that the concentrate produced has a dry matter content that is higher by about 0.5 to 4% by weight, allowing the dry matter content of the concentrate within the stacked container V1 to increase to at least 51% by weight;
(c) shutting down, rinsing, and removing of product from the evaporation reactor R1 using water, in the process of which concentrate is continued to be fed into the first stacked container V1 until the dry matter content therein has decreased to about 50% by weight, and, subsequently,
(d) feeding the concentrate, which had been diluted with the rinsing water, into another stacked container V3, where the mixed phase MP2 having a dry matter content of about 35 to 40% by weight such obtained is gathered, and is then further processed or discharged.

In simplified terms, the plant operator increases the performance of the evaporator in good time before he shuts down and cleans the reactor due to high bacterial contamination, so that a concentrate having a higher content of, for example, 51 or 52% by weight dry matter is produced for a particular period of time, instead of a concentrate having about 50% by weight dry matter, as usual; this leads to the fact that also the dry matter content in the stacked container the reactor is entering gradually increases. This can be performed at the flick of a switch, as the starting-up and shutting-down of the reactors and the changing of the collecting containers as well as the determination of the dry matter contents can be operated fully automatically by means of corresponding electronics and pertaining programming.

While until now shutting-down the reactor also involved changing the stacked container at the same time, as the concentrate still in the reactor that is being drained is quickly diluted by the rinsing water, it is possible, within the meaning of the present invention, to wait a little; more precisely, as long as the dry matter content of the collecting container—which had been increased before—is reduced to the target dry matter content of at least 50% by weight by the diluted concentrate. In doing so, comparably more valuable concentrate may be collected as a valuable product, reducing the amount of worthless mixed phase in return. Consequently, the higher energy demand within the evaporator, which is required for a short time in order to increase the dry matter content within the collecting container, is of no importance.

Surprisingly, it was found that such process optimisation allows to about halve the amount of undesired mixed phase, which means that approximately 1,500 kg of waste products are avoided, based on an extrapolation of waste product occurrence in a plant with a throughput of about 20,000 litres per hour. A mixed phase is produced at the same time, which has a significantly lower dry matter content, which means reduced losses of valuable product on the one hand, and which facilitates its discharge, as there are less costs, on the other.

### DETAILED DESCRIPTION

In a first preferred embodiment of the invention, the process described above is modified such that following step (c) one proceeds as follows:
(d1) feeding the concentrate that has been diluted by the rinsing water into another stacked container V2 until obtaining a mixed phase MP1 having a dry matter content of 10 to 20% by weight, and, subsequently,
(d2) feeding the concentrate that has been diluted by the rinsing water into a stacked container V3 where the mixed phase MP2 having a dry matter content of about 5 to 15% by weight such obtained is collected, and is then either processed or discharged.

In simple words, the concentrate that has been diluted by the rinsing water is distributed to two stacked containers, wherein the container V2 receives the first, comparably higher concentrated amount of mixed phase, which may then be processed to a valuable product, as is explained below, and only the second, highly diluted mixed phase is collected in a third collecting container, and is eventually discharged.

This first preferred embodiment is in close connection with the following, second preferred variant by proceeding as follows:
(a) continuously concentrating a dairy stream having a dry matter content of about 30 to about 40% by weight in an evaporation reactor R1 until obtaining a dry matter content of about 50% by weight, and feeding the concentrate such obtained into the first stacked container V1 for a running period of about 5 to about 15 hours, draining the container discontinuously and processing the concentrate contained therein;
(b) increasing the performance of the evaporation reactor R1 for a maximum of 2 hours before the scheduled end of the respective running period such that the concentrate obtained has a dry matter content that is higher by about 0.5 to 4% by weight, allowing the dry matter content of the concentrate within the stacked container V1 to increase to at least 51% by weight;
(c) shutting down, rinsing, and removing of product from the evaporation reactor R1 using water, while concentrate is continued to be fed into the first stacked container V1 until the dry matter content therein has decreased to about 50% by weight;
(d) feeding the concentrate that has been diluted by the rinsing water into a second stacked container V2 until obtaining a mixed phase MP1 having a dry matter content of 10 to 20% by weight,
(e) simultaneously, starting up a second evaporation reactor R2 and redirecting the dairy stream into said reactor, concentrating the dairy stream until obtaining a dry matter content of about 50% by weight in the process, and feeding the concentrate such obtained for a running period of about 5 to about 15 hours into the second stacked container V2 while mixing it with the mixed phase MP1, which had already been fed in there, whereby the stacked container V2 is also drained discontinuously and the concentrate contained therein is processed; and
(f) feeding the concentrate, which has been diluted by the rinsing water from the evaporation reactor R2, into a stacked container V3 where the mixed phase MP2 having a dry matter content of about 5 to 15% by weight such obtained is collected, and is then processed or discharged.

This variant thus applies the process to the two alternately operated reactors, while the second stacked container having the higher concentrated mixed phase described above acts as the stacked container for the second reactor. During filling, the dry matter content gradually increases until reaching the desired value of about 50% by weight; this measure, in sum, allows that further amounts of mixed phase are transformed into valuable product, which would have been discharged otherwise. A further suitable alternative consists in running the second evaporator at a higher performance at the beginning of the running period, producing a concentrate having a dry matter content of 51 to 52% by weight, and feeding it into the stacked container V2 with the diluted product in order to achieve the target value of dry matter content of 50% by weight also in this collecting container more quickly. The higher performance is maintained until reaching the target value of the dry matter content in the stacked container V2.

Process Measures

The following further embodiments relate to embodiments of the process, which alone or together are not only typical, but also advantageous at the same time, because they have proved to be process-economic.

The process starts by increasing the performance of the evaporation reactor in step (b) for about 60 to 90 minutes before the scheduled end of the running period in each case, usually alternately operating the two evaporation reactors R1 and R2 as described above. The running periods are typically 6 to 12 hours until cleaning is required due to an increasing bacterial contamination.

Skimmed milk is preferably concentrated, however, other dairy streams are also suitable, whereby the throughput is about 15,000 to about 25,000 kg/h, and the amount of concentrate obtained is about 10,000 to about 20,000 kg/h, depending on the plant.

Usually, evaporation reactors of the mechanical vapour compressor type are employed, which are operated at a temperature within the range of 60 to 100° C., and preferably of 70 to 90° C. In doing so, in step (b) the performance of the evaporation reactor is preferably increased such that the condensate obtained has a dry matter content of about 50.7 to 52% by weight, and the dry matter content in the stacked container V1 in step (b) is about 51 to 52% by weight. The dry matter content of the mixed phase MP1 in the stacked container V2 is preferably adjusted to about 15 to about 20% by weight. The stacked containers may have a volume of about 2,000 to about 10,000 litres.

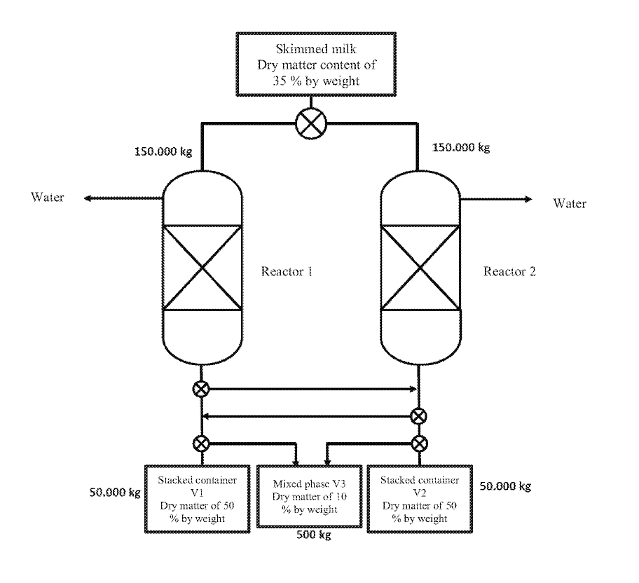

The process of the invention according to the second preferred embodiment is schematically illustrated in FIG. 1; the amounts correspond to a running period of 10 hours for each reactor. In contrast to the conventional process without an intermediate increase of the dry matter contents in the collecting containers, a reduction of the amount of mixed phase by more than 50% is achieved.

### EXAMPLES

### Comparison Example V1

A concentration plant, consisting of two evaporators equipped with mechanical vapour compression and having a throughput of 15,000 litres/h each was alternately fed with a continuous stream of skimmed milk having a dry matter content of 35% by weight. Concentration was performed at 80° C. The concentrate having a dry matter content of 50% by weight was continuously fed into a collecting container having a volume of 5,000 litres, which was regularly drained. The performance of each evaporator was 10,000 litres of condensate per hour.

After a running time of 10 hours, the first reactor was shut down, and the dairy stream was redirected to the pre-heated and operational second reactor. The first reactor was rinsed with water at a throughput of 10,000 litres/h, and the concentrate still present in the reactor was pressed out, along with the rinsing water, into a fresh collecting container. 1,000 kg mixed phase having a dry matter content of 32% by weight were obtained, which were subsequently discharged.

The second reactor was treated analogously. After two running periods of 10 hours each, the amount of mixed phase was 2,000 kg.

### Example 1

Comparison example V1 was repeated, however, after a running time of 9 hours the performance of the first reactor was increased such that a concentrate having a dry matter content of 52.5% by weight was produced, which mixed with the concentrate that was already present in the collecting container such that the dry matter content amounted to 51.2% by weight at the end of the 10-hour running period.

After shutting off the first reactor and redirecting the dairy stream to the second evaporator, the first reactor was rinsed with water, as described above, the concentrate, however, which was increasingly diluted by the rinsing water, was guided into the first collecting container until the dry matter content had decreased to 50% by weight. Only at this point the diluted concentrate was redirected into a second collecting container and introduced there until the dry matter content began to fall below a value of 15% by weight. At this point in time, the heavily diluted concentrate was redirected into a third collecting container, where 500 kg of a mixed phase were eventually collected, which only had a dry matter content of 10% by weight.

In the meantime, the amount of concentrate produced in the second reactor was introduced into the second stacked container, where the dry matter content gradually increased up to 50% by weight. At the end of the two 10-hour running periods, 1,000 kg mixed phase having a dry matter content of 10% by weight were obtained.

1. A process for reducing the occurrence of mixed phases when concentrating dairy streams, comprising the following steps:
(i) providing at least one evaporation reactor;
(ii) providing at least two stacked containers, which can be controlled individually by one or both evaporation reactors;
by proceeding as follows:
(a) continuously concentrating a dairy stream having a dry matter content of about 30 to about 40% by weight in an evaporation reactor R1 until obtaining a dry matter content of about 50% by weight, and feeding the concentrate such obtained into the first stacked container V1 for a running period of about 5 to about 15 hours, draining the container discontinuously and processing the concentrate contained therein;
(b) increasing the performance of the evaporation reactor R1 for a maximum of 2 hours before the scheduled end of each respective running period such that the concentrate produced has a dry matter content that is higher by about 0.5 to 4% by weight, allowing the dry matter content of the concentrate within the stacked container V1 to increase to at least 51% by weight;
(c) shutting down, rinsing, and removing of product from the evaporation reactor R1 using water, in the process of which concentrate is continued to be fed into the first stacked container V1 until the dry matter content therein has decreased to about 50% by weight, and, subsequently,
(d) feeding the concentrate, which had been diluted with the rinsing water, into another stacked container V3, where the mixed phase MP2 having a dry matter content of about 35 to 40% by weight such obtained is gathered, and is then further processed or discharged.

2. The process, according to claim 1, following step (c), the process further comprises:
(d1) feeding the concentrate that has been diluted by the rinsing water into another stacked container V2 until obtaining a mixed phase MP1 having a dry matter content of 10 to 20% by weight, and, subsequently,
(d2) feeding the concentrate that has been diluted by the rinsing water into a stacked container V3 where the mixed phase MP2 having a dry matter content of about 5 to 15% by weight such obtained is collected, and is then either processed or discharged.

3. A process for reducing the occurrence of mixed phases when concentrating dairy streams, comprising the following steps:
(i) providing at least one evaporation reactor;
(ii) providing at least two stacked containers, which can be controlled individually by one or both evaporation reactors;
by proceeding as follows:
(a) continuously concentrating a dairy stream having a dry matter content of about 30 to about 40% by weight in an evaporation reactor R1 until obtaining a dry matter content of about 50% by weight, and feeding the concentrate such obtained into the first stacked container V1 for a running period of about 5 to about 15 hours, draining the container discontinuously and processing the concentrate contained therein;
(b) increasing the performance of the evaporation reactor R1 for a maximum of 2 hours before the scheduled end of the respective running period such that the concentrate obtained has a dry matter content that is higher by about 0.5 to 4% by weight, allowing the dry matter content of the concentrate within the stacked container V1 to increase to at least 51% by weight;
(c) shutting down, rinsing, and removing of product from the evaporation reactor R1 using water, while concentrate is continued to be fed into the first stacked container V1 until the dry matter content therein has decreased to about 50% by weight;
(d) feeding the concentrate that has been diluted by the rinsing water into a second stacked container V2 until obtaining a mixed phase MP1 having a dry matter content of 10 to 20% by weight,
(e) simultaneously, starting up a second evaporation reactor R2 and redirecting the dairy stream into said reactor, concentrating the dairy stream until obtaining a dry matter content of about 50% by weight in the process, and feeding the concentrate such obtained for a running period of about 5 to about 15 hours into the second stacked container V2 while mixing it with the mixed phase MP1, which had already been fed in there, whereby the stacked container V2 is also drained discontinuously and the concentrate contained therein is processed; and
(f) feeding the concentrate, which has been diluted by the rinsing water from the evaporation reactor R2, into a stacked container V3 where the mixed phase MP2 having a dry matter content of about 5 to 15% by weight such obtained is collected, and is then processed or discharged.

4. The process, according to claim 1, wherein in step (b) the performance of the evaporation reactor is increased in each case about 60 to 90 minutes before the scheduled end of the running period.

5. The process, according to claim 1, wherein the two evaporation reactors R1 and R2 are alternately operated in each case.

6. The process, according to claim 1, wherein the evaporation reactor, or the evaporation reactors, are each operated for a running period of 6 to 12 hours.

7. The process, according to claim 1, wherein skimmed milk is concentrated.

8. The process, according to claim 1, wherein dairy streams are concentrated with a throughput of about 15,000 to about 25.000 kg/h.

9. The process, according to claim 1, wherein condensate in an amount of about 10,000 to about 20,000 kg/h is removed from the evaporation reactor.

10. The process, according to claim 1, wherein evaporation reactors of the mechanical vapour compressor type are employed.

11. The process, according to claim 1, wherein the evaporation reactors are operated at a temperature within the range of 60 to 100° C.

12. The process, according to claim 1, wherein the performance of the evaporation reactor in step (b) is increased such that the condensate obtained has a dry matter content of about 50.7 to 52% by weight.

13. The process, according to claim 1, wherein the dry matter content in the stacked container V1 in step (b) is increased to 51 to 52% by weight.

14. The process, according to claim 2, wherein the dry matter content of the mixed phase MP1 in the stacked container V2 is adjusted to about 15 to about 20% by weight.

15. The process, according to claim 1, wherein the second evaporation reactor is operated at a higher performance at the beginning of the running time such that a concentrate having a dry matter content of 51 to 52% by weight is obtained, which is then mixed with the diluted concentrate in the stacked container V2.
